(19) United States
(12) Patent Application Publication
(10) Pub. No.: US 2008/0276479 A1
(43) Pub. Date: Nov. 13, 2008

(54) Hair Dryer

(75) Inventors: Eul-Chul Byun, Gyeongsangbuk-do (KR); Heung-Geun Park, Gyeongsangbuk-do (KR); Won-Lee Joh, Gyeongsangbuk-do (KR)

Correspondence Address: LOWE HAUPTMAN HAM & BERNER, LLP, 1700 DIAGONAL ROAD, SUITE 300, ALEXANDRIA, VA, 22314, US

(73) Assignees: Eul-Chul Byun, Gyeongsangbuk-do (KR); Heung-Geun Park, Gyeongsangbuk-do (KR); Won-Lee Joh, Gyeongsangbuk-do (KR); BESTLOGIS CO., LTD., Gyeongsangbuk-ko (KR)

(21) Appl. No.: 11/630,638

(22) PCT Filed: Nov. 4, 2004
(86) PCT No.: PCT/KR2004/002834

§ 371 Date: Jun. 9, 2008

(30) Foreign Application Priority Data
Jun. 29, 2004 (KR) 20-2004-0018911

(51) Int. Cl. A45D 20/12; H05B 3/10; A45D 20/10

(52) U.S. Cl. 34/97; 219/553; 392/385

(57) ABSTRACT

Disclosed is a hair dryer capable of improving convenience in handling, changing a temperature range of a blown air variously, and generating anions in the blown air. The hair dryer includes a manipulating panel (12) in which switches (S1,S2,S3,S4) are independently mounted, a first microprocessor (MPU1)(100) for transmitting an input signal input from each switch to a second microprocessor (MPU2)(200), and a second microprocessor (MPU2)(200) for controlling operation the driving motor according to the input signal and classifying a connection interval of electric current applied to the heating coil (C). The hair dryer allows a temperature range to be variously controlled, so the hair dryer may be utilized in more various fields, and because of using a single heating coil C, the hair dryer has very simple inner configuration, thereby reducing manufacture costs remarkably.

### TECHNICAL FIELD

The present invention relates to a hair dryer, and more particularly to a hair dryer capable of improving convenience in handling, changing a temperature range of a blown air variously, and generating anions in the blown air.

### BACKGROUND ART

A general hair dryer is configured so that a plurality of heating coils (nickel-chrome wires) are separately installed on a support made of metal, and a connection terminal is installed to each heating coil on the support so as to allow current flow. Thus, an air blown by a driving motor (or, a driving fan) is heated around the support by means of the heat generated in the heating coils.

The conventional hair dryer adjusts a heating temperature range by selecting the number of heating coils electrically connected. Thus, due to many heating coils and connection terminals, the conventional hair dryer is complicated, causes frequent defects such as a short circuit, and exposes users to the danger of electric accidents since many wires are entangled.

In addition, the conventional hair dryer has limitations in adjusting a temperature range since the temperature is adjusted by means of the number of heating coils. In addition, since the conventional hair dryer is manipulated with a sliding switch or a multi-connection push button, exactly controlling each component is difficult and such manipulating operations are very inconvenient. Moreover, the conventional hair dryer discharges smoky smells generated by the heating coils together with an air, which gives unpleasantness to users.

### DISCLOSURE OF INVENTION

The present invention is designed to solve such problems of the conventional hair dryer, and therefore an object of the invention is to provide a hair dryer that allows various adjustment of temperature ranges with a simple structure using one heating coil (nickel-chrome wire) so that the hair dryer may be applied in various fields and have improved convenience and accuracy in manipulating and operating, and installs the heating coil around a support made of jade so that a large amount of far infrared rays and anions is discharged together with a blown air and smells generated from the heating coil is neutralized.

An interval of electric connection applied to a single heating coil mounted in a blowing hole of a hair dryer is classified into several stages by control of an electric connection interval controller so that a temperature is adjusted by the interval (time) of electric current applied to the heating coil. In addition, a support made of mica with substantially no thermal conductivity is mounted on a surface of jade structure made of jade, and the heating coil is installed around the support so that the heat from the heating coil does not give a direct impact on the jade structure.

The hair dryer suggested in the present invention may be utilized in more diverse fields since a temperature range may be adjusted more variously. In addition, the hair dryer has a very simple inner configuration by using a single heating coil, thereby reducing manufacture costs and decreasing defects and danger of electric accidents. Moreover, since the hair dryer is manipulated by manipulation switches with classified functions and its operation state is displayed on a display window, the hair dryer gives more accurate operation and improved convenience.

In addition, the hair dryer of the present invention discharges a large amount of far infrared rays and anions useful for the human body in the air blown by the jade structure that configures the support of the heating coil. Moreover, since the jade neutralizes smell generated when the heating coil is heated, the hair dryer may make a user be refreshed. In addition, the heating of the heating coil prevents the jade structure from being damaged, so the hair dryer may be used for a long time.

### BRIEF DESCRIPTION OF THE DRAWINGS

FIG. 1 is a partially-sectioned front view showing a hair dryer according to a preferred embodiment of the present invention;

FIG. 2 is an exploded perspective view showing a heating coil support used in the hair dryer of the present invention;

FIG. 3 is a block diagram showing a hair dryer according to the present invention;

FIG. 4 is a perspective view showing a heating coil support according to another embodiment of the present invention; and

FIG. 5 is a perspective view showing a heating coil support according to still another embodiment of the present invention.

### BEST MODE FOR CARRYING OUT THE INVENTION

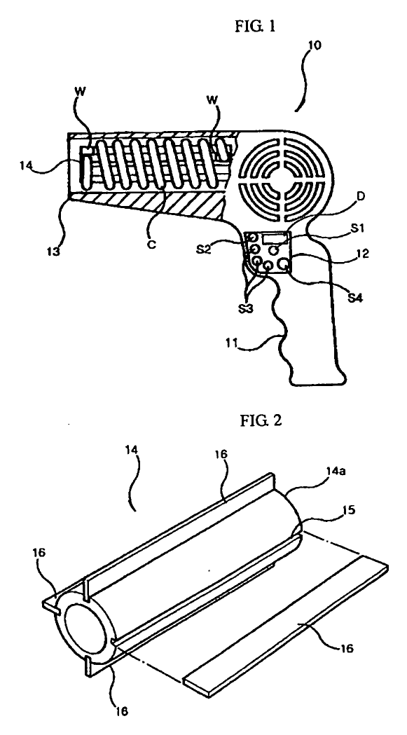

FIG. 1 is a partially-sectioned front view showing a hair dryer 10 according to a preferred embodiment of the present invention. As shown in FIG. 1, the hair dryer 10 of the present invention includes a manipulation panel 12 mounted to a handle 11. In addition, switches such as an operation switch S1 for applying power to the manipulation panel 12 so as to initiate operation of a driving motor (not shown), an air volume control switch S2 for controlling a speed of the driving motor so as to increase power (or, air volume) of the air blown, a temperature control switch S3 for controlling a temperature range, and a stop switch S4 for interrupting power are independently installed. At one side of the manipulation panel 12, a display window D for displaying an operation state of the hair dryer 10 is mounted.

At this time, there are at least two temperature control switches S3, and a first microprocessor (MPU1) 100 is mounted to the other side of the manipulation panel 12 so that input signals from the switches S1, S2, S3 and S4 are transmitted to a second microprocessor (MPU2) 200.

A heating coil support 14 is mounted in a blowing hole 13 of the hair dryer 10, and a single heating coil C is installed around the heating coil support 14. Both ends of the heating coil C are connected to a connection terminal W mounted at one end of the heating coil support 14.

Meanwhile, though it is described in an embodiment of the present invention that the manipulation panel 12 is installed on the handle 11 of the hair dryer 10, the manipulation panel 12 may be installed on a main body 10a of the hair dryer 10 that is contacted with the handle 11, and an installation position of the manipulation panel 12 does not give an influence on effects desired by the present invention.

FIG. 2 is an exploded perspective view showing the heating coil support 14 adopted in the present invention. As shown in FIG. 2, the heating coil support 14 is configured so that at least two mount grooves 15 are formed on a surface of a jade structure 14a having a pipe shape and made of jade and then a support 16 made of mica is fit in each mount groove 15. Here, the heating coil C is installed around the support 16 that is protruded over the jade structure 14a. At this time, the heating coil support 14 is configured as mentioned above since a heat generated in the heating coil C may break down the jade if the heating coil C is directed contacted with the jade.

Meanwhile, the jade structure 14a may have various pipe shapes such as circular and polygonal pipe shapes. Since the shape of the jade structure 14a does not give an influence on effects realized by the heating coil support 14, the shape of the jade structure 14a is not limited to such a circular or polygonal pipe shape.

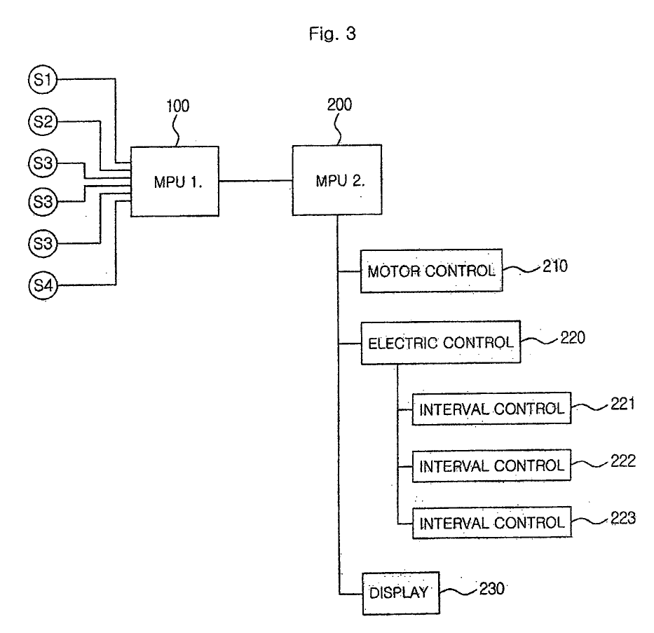

FIG. 3 is a block diagram showing the hair dryer according to the present invention. As shown in FIG. 3, it is found that MPU1 100 is connected to MPU2 200 so as to exchange data, and an input signal input from each switch S1, S2, S3 or S4 is transmitted to MPU2 200 through MPU1 100.

MPU2 200 includes a motor controller 210 programmed to control a driving speed of the driving motor together with controlling operation and stop of the driving motor according to the input signal so that the power of the blown air is adjusted stronger or weaker, a connection controller 220 for applying or interrupting power toward the heating coil C according to the input signal, and a display 230 programmed to output a current operation state (e.g., air volume, temperature and so on) of the hair dryer 10 on the display window D.

In the connection controller 220, first, second and third connection interval control units 221, 222 and 223 programmed to repeatedly connect and disconnect electric power supplied to the heating coil C at different time intervals are prepared. According to each connection interval of the first, second and third connection interval control unit 221, 222 and 223, a temperature range of the heating coil C is classified into several steps.

Meanwhile, in the embodiment of the present invention, it is described that the connection/disconnection interval of electric current applied to the heating coil C is controlled into three steps. However, the connection/disconnection interval of electric current may be controlled into more steps than three, and such configuration related to the steps of electric current connection/disconnection (that is ultimately steps of temperature range) may be selected as a user desires during the manufacturing procedure.

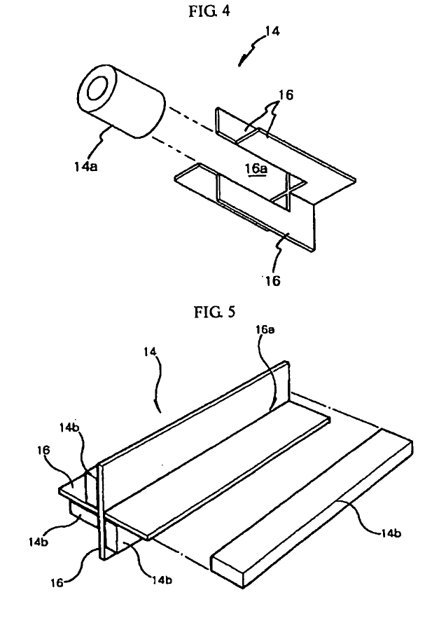

FIG. 4 shows another embodiment of the heating coil support 14 according to the present invention. As shown in FIG. 4, the heating coil support 14 of this embodiment is configured so that one ends of supports 16 made of mica and radially arranged are connected to form a combination region 16a in the supports 16, which is restricted by the supports 16, and a jade structure 14a is fit into the combination region 16a. In this configuration, it is possible to exclude a process of processing the jade structure 14a itself.

FIG. 5 shows still another embodiment of the heating coil support 14 according to the present invention. As shown in FIG. 5, the heating coil support 14 of this embodiment is configured so that supports 16 made of mica and having a plate shape are mounted to be crossed with each other to form partitioned surfaces 16a thereon in a length direction of the supports 16. A connection terminal W is mounted to one side of the support 16, and a jade plate 14b made of jade is attached to each partitioned surface 16a. At this time, the jade plate 14b is not protruded out of the supports 16 so that the heating coil C installed around the supports 16 is not directly contacted with the jade plate 14b.

In the hair dryer of the present invention configured as mentioned above, the driving motor is operated or stopped by means of the operation switch S1 and the stop switch S4, and an air volume to be blown is controlled by means of the air volume control switch S2.

The hair dryer of the present invention also allows a temperature range to be controlled by means of at least one temperature control switch S3. If each temperature control switch S3 is manipulated, a signal is input to a corresponding one of the connection interval control units 221, 222 and 223, and then this connection interval control unit 221, 222 or 223 repeats connection and disconnection of electric current supplied to the heating coil C at a programmed interval so as to control a heating temperature of the heating coil C. A series of such operating states is displayed on the display window D, so a user may easily check a current state of the hair dryer 10.

While an air generated by the driving motor and a driving fan is blown outward via the heating coil support 14 provided in the blowing hole 13, the air is heated by means of the heating coil C installed around the heating coil support 14. During this procedure, beneficial components generated in the jade structure 14a or the like of the heating coil structure 14 are included in the heated air blown. In addition, the jade structure 14a of the heating coil structure 14 plays a role of neutralizing smoky smells generated while the heating coil C is heated.

In addition, in the hair dryer of the present invention, the jade structure 14a is not directly contacted with the heating coil C, thereby preventing the jade structure 14a from being broken down due to the heat of the heating coil C. Moreover, the support 16 for supporting the heating coil C is made of mica that has substantially no thermal conductivity, thereby preventing the heat of the heating coil C from being conducted to damage the jade structure 14a. The present invention will now be described in detail in connection with preferred embodiments with reference to the accompanying drawings. For reference, like reference characters designate corresponding parts throughout several views.

### INDUSTRIAL APPLICABILITY

The hair dryer 10 proposed in the present invention allows a temperature range to be variously controlled, so the hair dryer may be utilized in more various fields. In addition, because of using a single heating coil C, the hair dryer 10 has very simple inner configuration, thereby reducing manufacture costs remarkably.

What is claimed is:

1. A hair dryer, comprising:
a single heating coil (C) installed around a heating coil support (14) mounted in a blowing hole (13) so as to be connected to a connection terminal (W);
a manipulating panel (12) having an operating switch (S1) for applying power and initiating operation of a driving motor, an air volume control switch (S2) for adjusting power (air volume) of a blown air, at least two temperature control switches (S3) for adjusting a temperature range, and a stop switch (S4) for interrupting power independently and having a display window (D) in a region adjacent to the switches;
a first microprocessor (MPU1)(100) for transmitting an input signal input from each switch (S1, S2, S3 or S4) to a second microprocessor (MPU2)(200); and
a second microprocessor (MPU2)(200) having a motor controller (210) programmed to control a driving speed of the driving motor together with controlling operation and stop of the driving motor by means of the input signal from MPU1 (100) so that the power of the blown air is adjusted stronger or weaker, a connection controller (220) for applying or interrupting power toward the heating coil (C) according to the input signal, and a display (230) programmed to output a current operation state (air volume, temperature and so on) of the hair dryer (10) on the display window (D).

2. The hair dryer according to claim 1,
wherein the connection controller (220) has first, second and third connection interval control units (221, 222 and 223) programmed to connect and disconnect electric power supplied to the heating coil (C) at different time intervals.

3. The hair dryer according to claim 1,
wherein the heating coil support (14) is configured so that at least two mount grooves (15) are formed on a jade structure (14a) made of jade and then a support (16) made of mica is fit into each mount groove (15).

4. The hair dryer according to claim 1,
wherein the heating coil support (14) is configured so that one ends of supports (16) made of mica and radially arranged are connected to form a combination region (16a) in the supports (16) and a jade structure (14a) is fit into the combination region (16a).

5. The hair dryer according to claim 1,
wherein the heating coil support (14) is configured so that supports (16) made of mica and having a plate shape are mounted to be crossed with each other to form partitioned surfaces (16a) thereon in a length direction of the supports (16) and a jade plate (14b) made of jade is attached to each partitioned surface (16a).
